(19) United States
(12) Patent Application Publication
(10) Pub. No.: US 2008/0138668 A1
(43) Pub. Date: Jun. 12, 2008

(54) DIRECT METHANOL FUEL CELL

(75) Inventors: Masato Akita, Yokohama-shi (JP); Ryosuke Yagi, Kawasaki-shi (JP); Yuusuke Sato, Tokyo (JP); Eiichi Sakaue, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/858,395

(22) Filed: Sep. 20, 2007

(30) Foreign Application Priority Data
Sep. 25, 2006 (JP) P2006-259503

(51) Int. Cl. H01M 8/02; B05D 3/00

(52) U.S. Cl. 429/12; 427/115

(57) ABSTRACT

A direct methanol fuel cell includes: an electrolyte membrane; an anode catalyst layer provided on one side of the electrolyte membrane, the anode catalyst layer accelerating the reaction of methanol with water to produce proton, electron and carbon dioxide; a cathode catalyst layer provided on the other side of the electrolyte membrane, the cathode catalyst layer accelerating the reaction between the proton, the electron and oxygen to produce water; a dense water-repelling layer having water-repelling property provided on the opposite side of the anode catalyst layer to the electrolyte membrane, the dense water-repelling layer being formed by calcining a slurry containing carbon powder and water-repelling polymer and having a thickness of 100 μm or more after calcination; and a porous gas-diffusing layer provided on the opposite side of the dense water-repelling layer to the anode catalyst layer.

The entire disclosure of Japanese Patent Application No. 2006-259503 filed on Sep. 25, 2006, including specification, claims, drawings and abstract is incorporated herein by reference in its entirety.

### BACKGROUND OF THE INVENTION

1. Field of the Invention

The present invention relates to a direct methanol fuel cell.

2. Description of the Related Art

In recent years, fuel cells have been spotlighted as a small-sized portable power source. Of them, a direct methanol fuel cell (DMFC) has particularly attracted attention in view of handling ease of the fuel and operating temperature.

Fundamental reactions of DMFC are as follows.

Anode electrode: CH₃OH+H₂O→CO₂+6H⁺+6e⁻ (chemical formula 1)

Cathode electrode: (3/2)O₂+6H⁺+6e⁻→3H₂O (chemical formula 2)

As is shown by the chemical formula 1, the anode electrode requires methanol and water molecules. For example, 6 protons and 6 electrons are generated from one molecule of methanol and one molecule of water with the aid of an alloy catalyst mainly including platinum and ruthenium, with producing one molecule of carbon dioxide as a waste. The electrons are utilized as electric output by allowing them to pass through an external electric circuit.

Also, as is shown by the chemical formula 2, the cathode electrode requires oxygen, protons and electrons. 6 Electrons react with 6 protons having been traveled through a proton conductive electrolyte membrane and 3/2 molecules of oxygen in the cathode electrode to produce 3 molecules of water as a waste.

That is, in DMFC, generation of electricity can be conducted by supplying the anode electrode with ideally a 1:1 mixture of methanol and water as a fuel. Generation of electricity can also be conducted by supplying the anode with a mixture containing a higher concentration of methanol, ideally methanol alone, with supplying part of water molecules having been generated in the cathode electrode to the anode electrode by some method.

In WO03/058743, a coated carbon paper, which is coated with a slurry of a mixture of a hydrophobic fluorinated polymer and carbon powder, is used as anode electrodes of DMFC.

In the above DMFC, consumption of water, which is not shown in the chemical formula 1, actually takes place in the fuel due to migration of protons or diffusion of water from the anode electrode to the cathode electrode. The consumption amount of water due to the diffusion can amount to about 20 times as much as the amount of water molecules consumed by the fundamental reaction, though depending upon characteristics of materials used in the electricity-generating portion and operating conditions. Thus, there have been no choices but to employ a fuel cartridge containing a more diluted fuel having a less volumetric energy density (a shorter electricity-generating time).

### SUMMARY OF THE INVENTION

According to an aspect of the present invention, there is provided a direct methanol fuel cell including: an electrolyte membrane; an anode catalyst layer provided on one side of the electrolyte membrane, the anode catalyst layer accelerating the reaction of methanol with water to produce proton, electron and carbon dioxide; a cathode catalyst layer provided on the other side of the electrolyte membrane, the cathode catalyst layer accelerating the reaction between the proton, the electron and oxygen to produce water; a dense water-repelling layer having water-repelling property provided on the opposite side of the anode catalyst layer to the electrolyte membrane, the dense water-repelling layer being formed by calcining a slurry containing carbon powder and water-repelling polymer and having a thickness of 100 μm or more after calcination; and a porous gas-diffusing layer provided on the opposite side of the dense water-repelling layer to the anode catalyst layer.

According to an aspect of the present invention, there is provided a production method of a direct methanol fuel cell including: coating a slurry containing carbon powder and water-repelling polymer; and calcining the slurry, wherein the direct methanol fuel cell having, an electrolyte membrane, an anode catalyst layer provided on one side of the electrolyte membrane, the anode catalyst layer accelerating the reaction of methanol with water to produce proton, electron and carbon dioxide, a cathode catalyst layer provided on the other side of the electrolyte membrane, the cathode catalyst layer accelerating the reaction between the proton, the electron and oxygen to produce water, a dense water-repelling layer having water-repelling property provided on the opposite side of the anode catalyst layer to the electrolyte membrane, the dense water-repelling layer being formed by calcining the slurry and having a thickness of 100 μm or more after calcination, and a porous gas-diffusing layer provided on the opposite side of the dense water-repelling layer to the anode catalyst layer.

### BRIEF DESCRIPTION OF THE DRAWINGS

Embodiment may be described in detail with reference to the accompanying drawings, in which:

FIG. 1 is a cross-sectional view showing the direct methanol fuel cell in accordance with the first embodiment;

FIG. 2 is a view showing an anode-side delivery plate in accordance with the first embodiment;

FIG. 3 is a view showing CCM in accordance with the first embodiment;

FIG. 4 is a view showing CCM in accordance with the first embodiment;

FIG. 5 is a view showing CCM in accordance with the second embodiment;

FIG. 6 is a view showing the direct methanol fuel cell in accordance with Example 1;

FIG. 7 is a view showing current-voltage characteristics of the direct methanol fuel cell in accordance with Example 1;

FIG. 8 is a view showing the α values of the direct methanol fuel cell in accordance with Example 1;

FIG. 9 is a view showing the direct methanol fuel cell in accordance with Example 3;

FIG. 10 is a view showing fuel permeability K of the direct methanol fuel cell in accordance with Example 3;

FIG. 11 is an electron micrograph showing the anode MPL layer in accordance with the third embodiment;

FIGS. 12A and 12B are electron micrographs showing the anode MPL layer in accordance with the third embodiment;

FIG. 13 is an electron micrograph showing the electricity-generating unit in accordance with the third embodiment.

### DETAILED DESCRIPTION OF THE INVENTION

Embodiments of the invention will be described in detail below by reference to drawings.

### First Embodiment

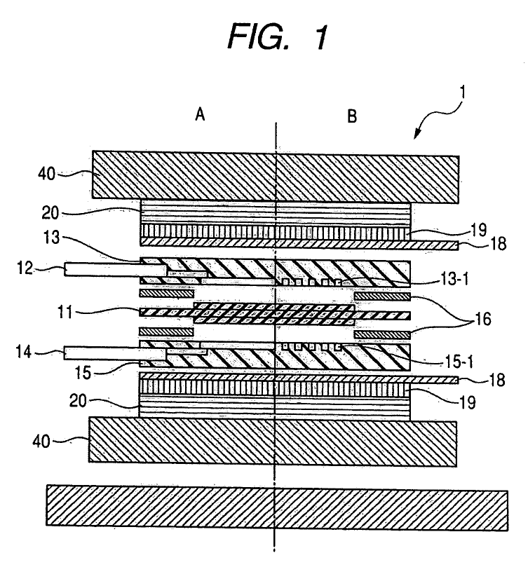

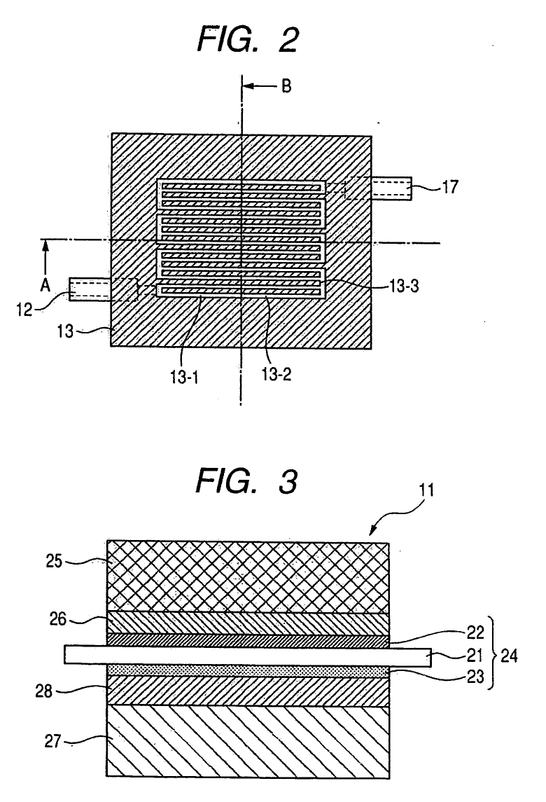

FIG. 1 is a cross-sectional view of a direct methanol fuel cell in accordance with a first embodiment. Signs of A and B in FIG. 1 show that the portion designated by A and the portion designated by B are cross-sections corresponding to the plane A and the plane B shown in FIG. 2, respectively.

Electricity-generating unit 11 is provided in a direct methanol fuel cell 1. An anode-side delivery plate 13 having a fuel-supplying inlet 12 for supplying a fuel is provided on the anode catalyst layer side in the electricity-generating unit 11. Also, a cathode-side delivery plate 15 having an air-supplying inlet 14 for supplying air is provided on the cathode catalyst layer side in the electricity-generating unit 11.

PFA-made gaskets 16 are provided between the electricity-generating unit 11 and the anode side delivery plate 13 and between the electricity-generating unit 11 and the cathode side delivery plate 15, respectively. The gaskets 16 are provided for the purpose of preventing leakage of a fuel from between the electricity-generating unit 11 and the anode side delivery plate 13 and leakage of air from between the electricity-generating unit 11 and the cathode side delivery plate 15.

A fuel flow passage 13-1 for supplying a fuel to the anode catalyst layer is provided in the anode side-delivery plate. Likewise, an air flow passage 15-1 for supplying air to the cathode catalyst layer is provided in the cathode side delivery plate 15. As is shown in FIG. 2 (anode-side delivery plate 13 being shown typically), the fuel flow passage 13-1 and the air flow passage 15-1 are provided, for example, in a serpentine pattern from the fuel-supplying inlet 12 toward the fuel-discharging outlet 17. The fuel flow passage 13-1 and the air flow passage 15-1 have a parallel flow passage portion 13-2 extending in the longitudinal direction of the electricity-generating unit 11 and a common flow passage portion 13-3 where flow passages of the parallel flow passage portions run into one passage portion and which extends in the transverse direction. Specifically, the flow passage has, for example, a width of 1 mm, a depth of 0.75 mm and a longitudinal length of 37 mm, with the flow passage being able to be turned 6 times.

Terminal plates 18 are provided, respectively, on the opposite side of the anode-side delivery plate 13 to the electricity-generating unit 11 and on the opposite side of the cathode-side delivery plate 15 to the electricity-generating unit 11 for supplying electric power generated in the electricity-generating unit 11 to an externally connected electric load. As the terminal plates 18, metal-made plates can be used.

A heater 19 is provided on the opposite side of each terminal plate 18 to the electricity-generating unit 11. The heaters 19 are provided for heating the electricity-generating unit 11 to a temperature within a predetermined range.

The electricity-generating unit 11, anode-side delivery plate 13, cathode-side delivery plate 15, gaskets 16, terminal plates 18 and heaters 18 are superposed and clamped between pressing plates 40 via heat-insulating members 20 using, for example, clamping bolts. As a result of being clamped between the pressing plates 40, the gaskets 16 function to prevent leakage of fuel and air from the fuel passage 13-1 and the air passage 15-1. Additionally, plural sets of the electricity-generating unit, anode-side delivery plate 13, cathode-side delivery plate 15 and gaskets 16 can be disposed in series to enhance output voltage of the direct methanol fuel cell.

FIG. 3 shows details of the electricity-generating unit 11.

The electricity-generating unit 11 is provided with CCM24 (catalyst Coated Membrane). CCM24 is provided with an electrolyte membrane 21. An anode catalyst layer 22 is provided on one side of the electrolyte membrane 21 for accelerating the reaction between methanol and water to generate electrons and carbon dioxide. Also, a cathode catalyst layer 23 is provided on the other side of the electrolyte membrane 21 for accelerating the reaction between protons, electrons and oxygen to generate water.

The CCM 24 can be formed according the following method. First, the electrolyte membrane 21 can be formed by subjecting a commercially available perfluorocarbonsulfonic acid membrane (for example, Nafion 112 from DuPont; trade name) cut into a piece of 40 mm×50 mm to a pre-treatment using a known method (G. Q. Lu et al., Electrochimica Acta 49 (2004), pp. 821-828).

As the anode catalyst layer 22, a product obtained by dispersing a Pt/Ru alloy catalyst manufactured by Johnson & Matthey (Pt/Ru Black HISPEC 6000) in a perfluorocarbonsulfonic acid solution (Nation solution manufactured by DuPont; Aldrich SE-29992 Nafion; 5 wt %) and coating the dispersion on a PTFE sheet. The coated amount of Pt/Ru in the dried anode catalyst layer 22 (hereinafter referred to as “loading amount”) is to be, for example, about 6 mg/cm².

As the cathode catalyst layer 23, a product obtained by dispersing a Pt/C catalyst manufactured by E-TEK (HP 40 wt % Pt on VulcanXC-72R) in a perfluorocarbonsulfonic acid solution (Nafion solution manufactured by DuPont; Aldrich SE-20092 Nafion; 5 wt %) and coating the dispersion on the PTFE sheet. The loading amount of Pt in the dried cathode catalyst layer 23 is to be about 2.6 mg/cm².

The CCM can be prepared by cutting each of the PTFE sheet having formed thereon the anode catalyst layer 22 and the PTFE sheet having formed thereon the cathode catalyst layer 23 into a 30 mm×40 mm piece, pressing both the anode catalyst layer 22 and the cathode catalyst layer onto the electrolyte membrane 21, and conducting thermocompression bonding at 125° C. and 10 kg/cm² for about 3 minutes.

Additionally, in the CCM 24 obtained by removing the PTFE sheets after the above-mentioned method, the thickness of the portions of the anode catalyst layer 22 and the cathode catalyst layer 23 is about 100 μm, with the thickness of the anode catalyst layer 22 being about 30 μm, and the thickness of the cathode catalytic layer 23 being about 30 μm.

On the anode catalyst layer 22 side of the CCM24 is provided an anode GDL layer 25 (anode electrode side porous gas diffusing layer). An anode MPL layer 26 (anode electrode side dense water-repelling layer) is provided between the anode catalyst layer 22 and the anode GDL layer 25.

On the cathode catalyst layer 23 side of the CCM24 is provided a cathode GDL layer 27 (cathode electrode side porous gas diffusing layer). A cathode MPL layer 28 (cathode electrode side dense water-repelling layer) is provided between the cathode catalyst layer 23 and the cathode GDL layer 27.

As the anode GDL layer 25, there can be used, for example, TGPH-090, 30 wt % Wetproofed, manufactured by E-TEK, which is obtained by subjecting carbon paper TGPH-090 manufactured by Toray Industries, Inc., to water-repelling treatment using about 30 wt % PTFE.

The anode MPL layer 26 can be prepared by employing a known process (G. Q. Lu et al., Electrochimica Acta 49 (2004) 821-828). The anode MPL layer can be formed, for example, in the following manner.

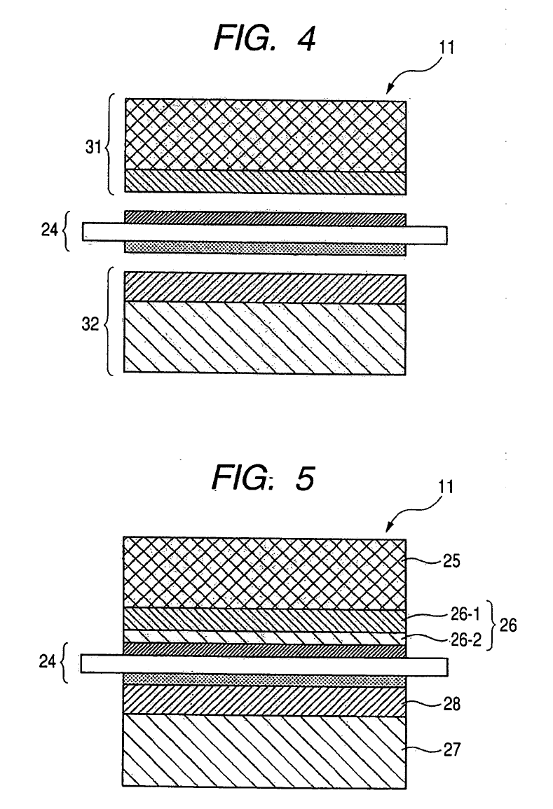

Carbon powder (VULCAN XC-72R) manufactured by CABOT and a 60 wt % emulsion of water-repelling PTFE (ALDRICH Polytetrafluoroethylene, 60 wt %, dispersion in water) are well mixed so that the weight of PTFE becomes about 50% by weight of the whole mixture to obtain a dispersion, and immediately coating the slurry having an adjusted viscosity on the anode GDL layer 25 by a tape casting method. The slurry-coated anode GDL layer 25 is dried at 100° C. after coating of the slurry and is subsequently calcined at 360° C. to obtain the anode GDL layer 31 having an MPL layer shown in FIG. 4.

The thickness of the anode MPL layer 26 is from about 100 to about 110 μm including both an MPL layer portion of from about 20 to about 30 μm formed by penetration into the anode GDL layer 25 from the surface of the anode GDL layer 25 and an MPL layer portion of about 80 μm formed on the surface of the anode GDL layer 25. The total thickness of the anode GDL layer 31 including the MPL layer is to be 380 μm.

As the cathode GDL layer 32 having the MPL layer wherein the cathode MPL layer 28 is provided on the cathode GDL layer 27, there can be used, for example, Elat GDL LT-2500-W (thickness: about 360 μm) manufactured by E-TEK can be used.

The CCM24, anode GDL layer 31 having the MPL layer and the cathode GDL layer 32 having the MPL layer are intimately superposed so that the anode catalyst layer 22 comes into contact with the anode MPL layer 26 and so that the cathode catalyst layer 23 comes into contact with the cathode MPL layer 28. The intimate superposing can be conducted by superposing the CCM24, anode GDL layer 31 having the MPL layer and the cathode GDL layer 32 having the MPL layer and conducting, for example, thermocompression bonding at 125° C. and 5 kg/cm² for 1 minute. The thickness of the entire electricity-generating unit 11 completed by the superposing is to be about 740 μm.

As the gasket 16, a PFA-made gasket 16 having a thickness corresponding to the thickness of the electricity-generating unit 11, for example, a 250-μm thick gasket 16, can be used on each of the anode catalyst layer 22 side and the cathode catalyst layer 23 side.

With the thus-prepared direct methanol fuel cell 1, the number of entrained water molecules (α value) per proton in the electricity-generating unit 11 is 0 or less, and thus diffusion of water from the anode electrode to the cathode electrode is suppressed, which enables generation of electricity using a fuel having a higher concentration of methanol. That is, a mechanism for mixing water contained in a discharged gas from the cathode side delivery plate 15 with a fuel in order to utilize the water for generation of electricity can be eliminated, which can contribute to downsize a system using the direct methanol fuel cell 1.

### Second Embodiment

FIG. 5 is a cross-sectional view of a direct methanol fuel cell in accordance with a second embodiment. Additionally, the same portions as in the direct methanol fuel cell in accordance with the first embodiment of the invention are designated by the same signs, with the descriptions thereof being omitted.

A first anode MPL layer 26-1 and a second MPL layer 26-2 are provided in the anode MPL layer 26. Such two-layer structure described above of the first anode MPL layer 26-1 and the second MPL layer 26-2 as the anode MPL layer 26 can suppress reduction in density of the anode MPL layer 26.

A method for preparing the anode MPL layer having the two-layer structure is described below. First, the first anode MPL layer 26-1 can be formed by tape casting method in the same manner as in the embodiment 1 so that the thickness of the dried layer becomes about 50 μm. Subsequently, the second MPL layer 26-2 can be formed by coating a slurry obtained by mixing carbon powder (VULCAN XC-72R) manufactured by CABOT and a 60 wt % emulsion of PTFE (ALDRICH Polytetrafluoroethylene, 60 wt %, dispersion in water) so that the weight of PTFE becomes about 50% by weight of the whole mixture without conducting adjustment of viscosity (in a state of a low viscosity) according to a pressure type spraying method in a thickness of about 50 μm, i.e., in a thickness of the anode MPL layer 26 of 100 μm, followed by drying and calcining.

The pressure type spraying can be performed by using, for example, a simple spray gun (Eclipse HP-CS) manufactured by Iwata. In spraying, the anode GDL layer 25 is preferably heated and maintained at a temperature higher than, for example, 50° C. so that the sprayed surface dose not get wet.

Reduction of density will be described in detail below. In the case of forming the anode MPL layer 26 having one-layer structure by employing the tape casting method as with the first embodiment, cracks generated in the surface become larger as the thickness becomes larger. Since cracks generated in the surface become larger, the coating density of the anode MPL layer 26 is reduced as is shown in Table 1.

TABLE 1
Coating density depending upon conditions for
coating a slurry of anode MPL layer

| | | Total | | |
|---|---|---|---|---|
| | | Thickness | | |
| | | of Anode | Weight | Weight |
| | Coating Method | MPL (μm) | (mg/cm2) | (g/cm3) |
| Examples | Tape casting method | 65 | 3.83 | 0.59 |
| 1-3 | | 175 | 7.04 | 0.40 |
| Example 4 | Tape casting method + | 178 | 10.23 | 0.58 |
| | Spraying method | | | |
| Example 5 | Spraying method | 206 | 10.52 | 0.51 |

On the other hand, cracks to be generated in the surface can be suppressed to a small degree by making the structure of the anode MPL layer 26 two-layer structure as in the embodiment of the invention. As is different from individual portions of the dense anode MPL separated from each other by the cracks as in the anode MPL layer 26 of one-layer structure, the two-layer-structure anode MPL layer 26 has a structure wherein pores of about ten and several μm in diameter are uniformly distributed. Although the anode MPL layer 26 having such two-layer structure has a smaller coating density than that of individual portions of the anode MPL, it has a higher coating density including the cracks than that of the anode MPL layer 26 having the one-layer structure. Therefore, as is shown by Table 1, the two-layer structure can prevent reduction in coating density of the anode MPL layer 26.

### Third Embodiment

A direct methanol fuel cell in accordance with a third embodiment is shown below. Additionally, the same portions as in the direct methanol fuel cell in accordance with the first and second embodiments of the invention are designated by the same signs, with the descriptions thereof being omitted.

While the anode MPL layer 26 is directly formed on the anode GDL layer 25 in the direct methanol fuel cell in accordance with the first and second embodiments, an anode GDL layer 31 having an MPL layer is formed in this embodiment by forming an anode MPL layer 26 of the two-layer structure, and then superposing the anode MPL layer 26 so that the second anode MPL layer 26-2 faces the anode catalyst layer 22.

The anode MPL layer 26 can be formed by employing the following method.

First, carbon paper TGPH-030 (about 100 μm in thickness) manufactured by Toray Industries, Inc. is to be prepared as a substrate. Additionally, as is different from the anode GDL layer 25, water-repelling treatment is not necessarily required. Over both sides of the substrate is sprayed the same slurry as that used for forming the second MPL layer 26-2 of the second embodiment using the pressure type spraying method to conduct spray filling. Here, “spray filling” is different from the coating using the pressure type spraying method having been described with respect to the second embodiment in the following point.

While the spray filling is the same as the coating using the pressure type spraying method in the point of spraying a slurry whose viscosity is not adjusted (slurry in a state of a low viscosity) over a substrate, the spray filling is different in the point that, in the spray filling, the spraying is conducted so that the sprayed portion on the substrate does not dry for at least several seconds, ideally about 10 seconds, to keep the wet state. For example, spraying with keeping the wet state as described above can be conducted by spraying with controlling the temperature of the carbon paper at about 50° C.

After forming the first anode MPL layer 26-1 by spray filling till the thickness of the coat including the carbon paper becomes about 200 μm, the second MPL layer 26-2 is formed on one side thereof by using the same method as with the second embodiment.

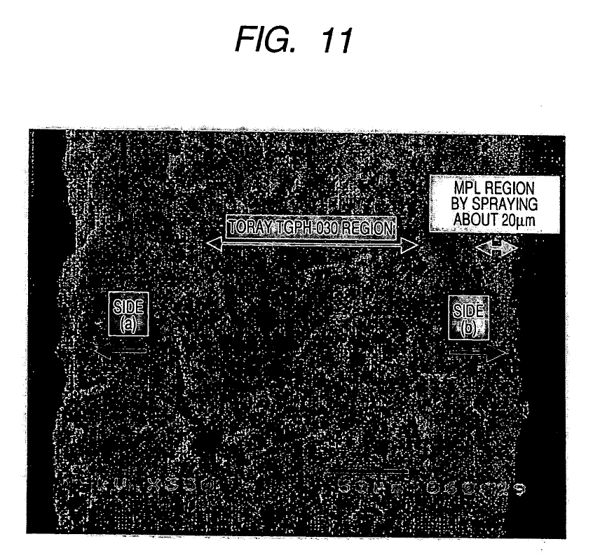

FIG. 11 shows one example of an electron micrograph of a cross-section of the anode MPL layer 26 in this embodiment. In FIG. 11, it is seen that the slurry is filled in the carbon paper of about 100 μm in thickness and, further, a 100-μm slurry is added thereon.

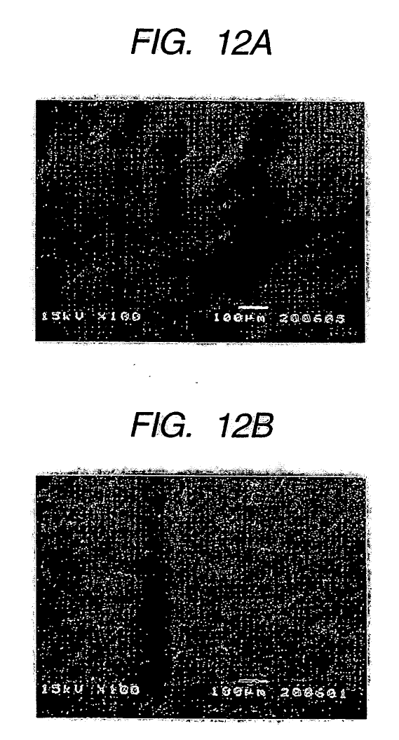

Also, FIGS. 12A and 12B show electron micrographs of the surface of the anode MPL layer 26. FIG. 12A is an electron micrograph of the surface viewed from side (a) shown in FIG. 11. FIGS. 12A and 12B show electron micrographs of the surface of the anode MPL layer 26. FIG. 12B is an electron micrograph of the surface viewed from side (b) shown in FIG. 11. In FIGS. 12A and 12B, it is seen that no cracks are formed on both side (a) and side (b). The structure of side (b) is a structure wherein pores of about ten and several μm are uniformly distributed as is the same as in the second embodiment.

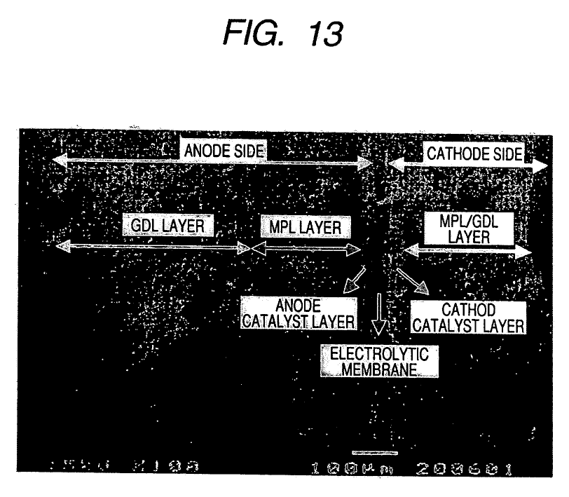

FIG. 13 shows an electron micrograph of cross-sectional view of the electricity-generating unit 11 using the anode MPL layer 26 prepared in this embodiment.

In FIG. 13, a carbon paper of about 200 μm in thickness having been subjected to water-repelling treatment is provided, as the anode GDL layer 25, on the opposite side of the anode MPL layer 26 to the anode catalyst layer 22. The cathode catalyst layer 23 and the MPL layer-having cathode GDL layer 32 are the same as in the first and the second embodiments. The thickness of the anode MPL layer 26 is about 220 μm, and the weight of the anode MPL layer 26 is from 14 to 16 μg/cm².

Since spray filling has been conducted by employing the pressure type spraying method, the thus-prepared direct methanol fuel cell 1 can suppress generation of cracks on the surface of the anode MPL layer 26. The first anode MPL layer 26-1 formed by spray filling according to the pressure type spraying method has a smaller density than that of the first anode MPL layer 26-1 formed by using the tape casting method but has a larger density than that of the second anode MPL layer 26-2, and can suppress generation of cracks. Therefore, the whole density of the anode MPL layer 26 can be made within a practical range.

Also, since generation of cracks is suppressed, in-plane unevenness of electric current density in the anode catalyst layer 22 due to the cracks can be suppressed.

### Example 1

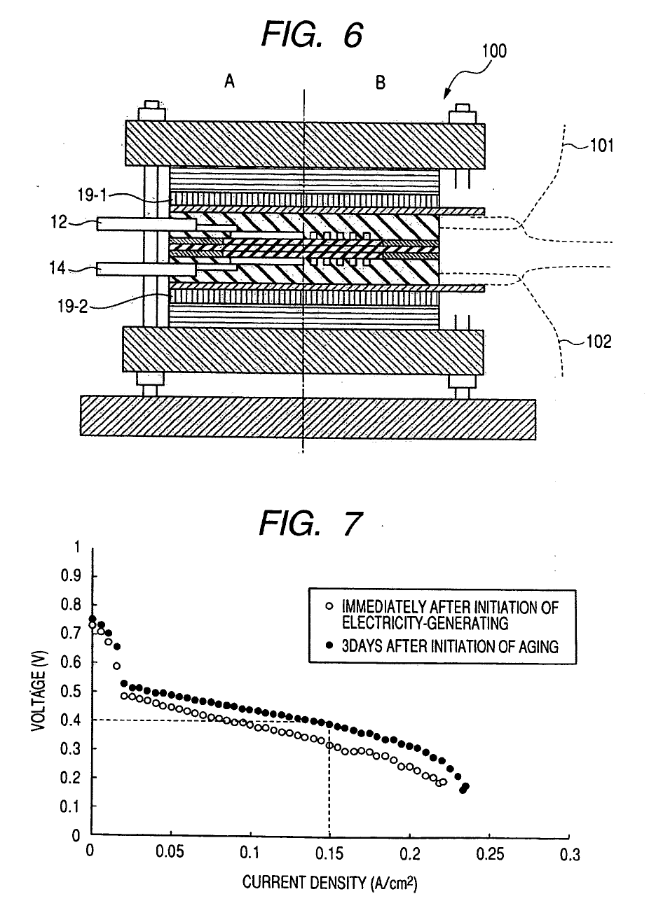

Electricity-generating test was conducted using a direct methanol fuel cell having one electricity-generating unit 11 shown in the first embodiment. The tested direct methanol fuel cell 100 is shown in FIG. 6. Additionally, the same portions as in the direct methanol fuel cell in accordance with the first embodiment of the invention are designated by the same signs, with the descriptions thereof being omitted.

Temperature sensors 101 and 102 were inserted into holes provided in the anode-side delivery plate 13 and the cathode-side delivery plate 15, respectively. The temperature sensor 101 was provided for measuring the temperature of the anode-side delivery plate 13, with the measured value being utilized for controlling a heater 19-1 provided on the side of the anode-side delivery plate 13. Likewise, the temperature sensor 102 was provided for measuring the temperature of the cathode-side delivery plate 15, with the measured value being utilized for controlling a heater 19-2 provided on the side of the anode-side delivery plate 15.

A fuel (an aqueous methanol fuel) of 2.0 mol/L in concentration was supplied through a fuel-supplying inlet 12 at a fuel-supplying amount of 0.2 cc/min.

An air (oxidizing agent) of 20.5% in oxygen concentration was supplied through an air-supplying inlet 14 at an air-supplying amount of 60 cc/min.

The temperatures measured by the temperature sensors 101 and 102 provided in the anode-side delivery plate 13 and the cathode-side delivery plate 15, respectively, were controlled to 60° C. by means of a temperature-adjusting device not shown, with preliminary heating of the air and the fuel not being conducted.

The current-voltage characteristics obtained by operating under the above-mentioned conditions are shown in FIG. 7.

In FIG. 7, the output voltage was about 0.3 V at a current density of 0.15 A/cm2 in the initial stage of the electricity-generating operation but, after 3 days, a voltage of 0.4 V was able to be obtained due to measurement of the current-voltage characteristics and repeated operation (aging) under a definite load of a constant current at 0.15 A/cm².

At the stage where voltage was no more improved, operation was conducted under a definite load of a constant current at 0.15 A/cm², water discharged from the cathode-side delivery plate 15 for a definite period of time as a liquid and a gas was recovered, and the amount of entrained water (α value) accompanying the migration of proton was calculated from the weight of water. Recovery of water was conducted by means of continuously connected two trap tubes cooled with ice-water, and the weight difference between before initiation of the measurement and after initiation thereof was taken as the weight of recovered water. Here, the amount of discharged gas is a flow amount of the gas having passed through the two trap tubes, and the discharge temperature was about 10° C.

Calculation of the amount of entrained water was conducted according to the following formulae.

mₜₒₜₐₗ=mₑ+mₓ+mₐ (formula 1)

mₑ=3600AI/2F (formula 2)

mₑ=2OₒᵤₜC_{CO2}/100R (formula 3)

In the formulae 1 to 3, mₜₒₜₐₗ represents the total amount (mol/h) of water discharged from the cathode electrode, mₑ represents the amount of water (mol/h) produced by oxidation of proton having migrated from the anode electrode to the cathode electrode, mₓ represents the amount of water (mol/h) produced by oxidation in the cathode electrode of methanol having cross-overed from the anode electrode, A represents the area (cm²) of the electricity-generating unit, I represents the current density (A/cm²) under a constant load, Oₒᵤₜ represents the flow amount of the discharged gas (L/h) after passing through the two trap tubes, C_{CO2} represents the concentration (%) of carbon dioxide in Oₒᵤₜ, F represents the Faraday's constant of 96500, and R represents a volume of 1 mol of gas at 273K of 2.4 (L).

The amount of entrained water ma (mol/h) accompanying migration of proton is calculated according to the formulae 1 to 3, and the α value (number of molecules), i.e., entrained water per proton, can be calculated from the formula 4 shown below.

α=mₐ/(3600AI/F) (formula 4)

The α values calculated by the above-mentioned procedures are shown in Table 2.

TABLE 2
Results in the test conducted under a load of a
constant electric current density, calculated cross-over
ratio and number of entrained water

| | |
|---|---|
| Electricity-generating | 60 |
| temperature (° C.) | |
| Area of electricity- | 12 |
| generating portion (cm²) | |
| Current density (A/cm²) | 0.15 |
| under a constant load | |
| Fuel concentration (M*) | 2 |
| Fuel-supplying amount | 0.3 |
| (cc/min) | |
| Air-supplying amount | 60 |
| (cc/min) | |
| Total amount of recovered | 0.847 |
| discharged water (g/h) | |
| Amount of discharged gas | 54 |
| (cc/min) | |
| Concentration of carbon | 5 |
| dioxide in the discharged | |
| gas (%) | |
| Output voltage (V/cm²) one | 0.357 |
| hour after initiation of | |
| applying a constant load | |
| cross-over ratio (%) | 39.3 |
| Number of entrained water | −0.015 |
| (α value) | |

*M: mol/l

As a result of the calculation, the α value was found to be smaller than 0. That is, diffusion of water from the anode electrode to the cathode electrode was suppressed, thus electricity generation being able to be performed by using a fuel having a higher methanol concentration.

### Example 2

Electricity-generating test was conducted using a direct methanol fuel cell having one electricity-generating unit shown in the first embodiment with changing the thickness of the anode MPL layer 26. Additionally, other constitutions and conditions were the same as in Example 1.

The electricity-generating test was conducted with 5 samples changing the thickness of the anode MLP layer 26 as 0 μm (anode MPL layer 26 being absent), 25 μm, 50 μm, 100 μm and 140 μm. Also, the electricity-generating test was conducted with adjusting the air-supplying amount through the air-supplying inlet 14 to two levels of 60 cc/min and 90 cc/min. Additionally, the thickness of the gasket 16 on the side of the anode catalyst layer 22 was adjusted so that the clamping pressure of CCM 24 became equal in accordance with the thickness of the anode MPL layer 26.

The α values when operated under the above-mentioned conditions are shown in Table 3.

TABLE 3
Dependence of α values upon thickness of anode
MPL layer

| | |
|---|---|
| Thickness | α Value |

| of MPL | Air-supplying Amount | Air-supplying Amount |
|---|---|---|
| Layer (μm) | 60 (cc/min) | 90 (cc/min) |
| 0 | 2.300 | 3.000 |
| 25 | 0.084 | 0.257 |
| 50 | 0.002 | 0.121 |
| 100 | −0.140 | 0.040 |
| 140 | −0.102 | 0.028 |

With every thickness of the anode MPL layer 26, the output voltage one hour after initiation of operation under a constant load at 0.15 A/cm2 was from 0.37 V to 0.39 V, thus difference in output voltage due to difference of the anode MPL layer 26 being small.

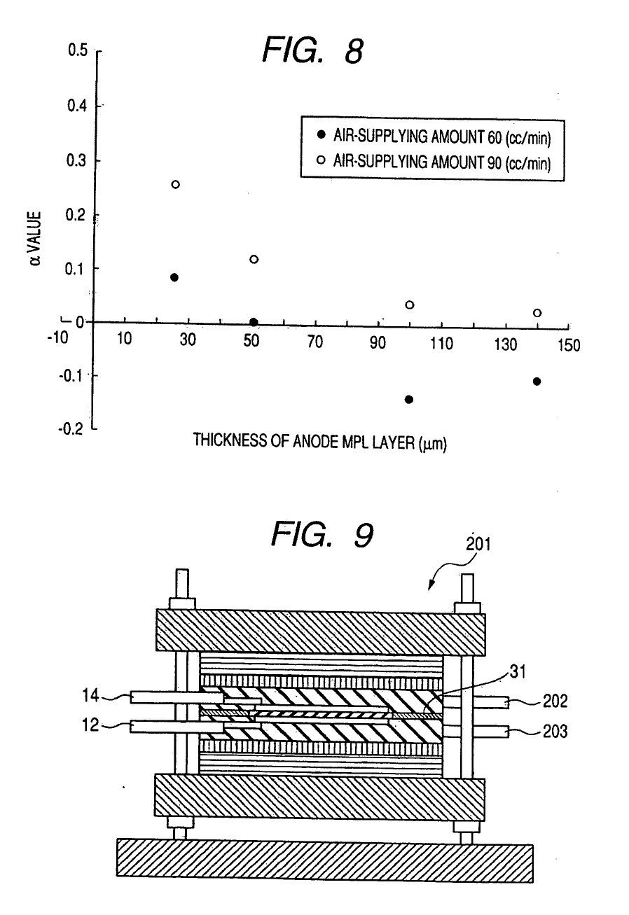

Regarding Table 3, results for the α values in the range of from −0.2 to 0.5 are shown in FIG. 8. As is shown in FIG. 8, the α value decreases with the increase of the thickness of the anode MPL layer 26 and, at a thickness of 100 μm or more, electricity-generating conditions were able to be found under which the α value became minus. That is, when the thickness of the anode MPL layer is at least 100 μm or more, α≦0 can be realized which enables use of a fuel having a methanol/water molar ratio of 1:1.

### Example 3

Permeability of a fuel through the MPL layer-having anode GDL layer 31 was evaluated with changing the thickness of the anode MPL layer 26 shown in the first embodiment. The direct methanol fuel cell 201 shown in FIG. 9 and used in the test was a direct methanol fuel cell which was constituted by changing the electricity-generating unit 11 of the direct methanol fuel cell 1 shown in FIG. 6 so that, in FIG. 9, the MPL layer-having anode GDL layer 31 was positioned so as to position the anode MPL layer 26 on the upper side. Additionally, the air-supplying inlet 14 and the fuel-discharging outlet 203 were closed in order for the fuel supplied through the fuel-supplying inlet 12 to reach the air-discharging outlet 202 with permeating through the MPL layer-having anode GDL layer 31. Also, the amount of fuel to be supplied through the fuel-supplying inlet 12 was adjusted so that the pressure difference between the fuel-supplying inlet 12 and the air-discharging outlet 202 became 50 Pa, 100 Pa or 200 Pa. Other constitutions and conditions were the same as in Example 2.

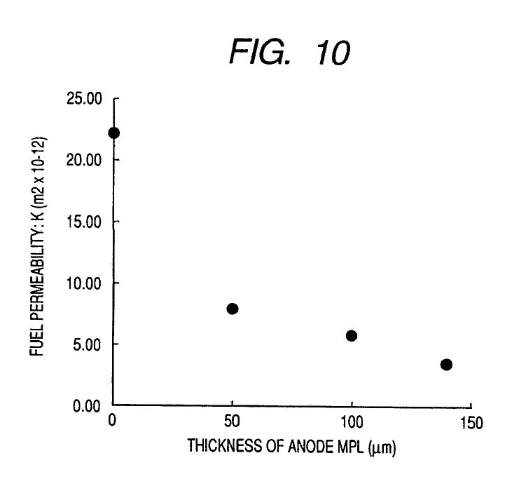

The fuel permeability K (m²×10⁻¹²) when operated under the above-mentioned conditions are shown in Table 4 and FIG. 10. Calculation of the fuel permeability was conducted in a known manner (M. V. Williams, Journal of The Electrochemical Society, 151(8), A1173-1180 (2004)). The experiment was conducted with closing the air-discharging outlet 202 and the fuel-discharging outlet 203. The measurement was conducted at room temperature (25° C.).

TABLE 4
Dependence of fuel permeability upon thickness
of anode MPL

| | | Difference | | |
|---|---|---|---|---|
| Thickness | | in | Fuel | |
| of Anode | Flow Amount | Pressure | Permeability | Average |
| MPL (μm) | of Fuel (cc/min) | (Pa) | (m² × 10⁻¹²) | Value |
| 0 | 0.353 | 50 | 20.90 | 22.167 |
| | 0.75 | 100 | 22.20 | |
| | 1.58 | 200 | 23.40 | |
| 50 | 0.14 | 50 | 8.30 | 8.003 |
| | 0.28 | 100 | 8.30 | |
| | 0.5 | 200 | 7.41 | |
| 100 | 0.08 | 50 | 5.69 | 5.870 |
| | 0.17 | 100 | 6.05 | |
| | 0.33 | 200 | 5.87 | |
| 140 | 0.083 | 100 | 2.95 | |
| | 9.23 | 200 | 4.09 | |

The flow amount of a fuel having been supplied through the fuel-supplying inlet 12, having migrated through the MPL layer-having anode GDL layer 31, and discharged from the air-discharging outlet 202, and the pressure difference between the fuel-supplying inlet 12 and the air-discharging outlet 202 were measured, and resistance (fuel permeability K) in passage of the fuel was calculated from the thus-obtained results.

It is seen from Table 4 and FIG. 10 that the thickness of the anode MPL layer 26 which realizes α≦0 provides a fuel permeability K of about 8×10⁻¹² or less.

Since the anode GDL layer 25 has a higher porosity than that of the anode MPL layer 26, the anode GDL layer 25 is required to have a thickness of nearly 1 mm in order to reduce the α value to a level of 0 or lower by suppressing the fuel permeability K when the anode MPL layer 26 has a small thickness. In the case of increasing the thickness of the anode MPL layer 26, however, a thickness of 100 μm or more is sufficient to exert enough effects. Therefore, increase in the thickness of the stack including the electricity-generating unit 11 can be suppressed. Further, since the anode MPL layer 26 has an extremely fine particle size distribution in comparison with the anode GDL layer 25, contacting properties with the catalyst layer can be improved.

### Example 4

Electricity-generating test was conducted using a direct methanol fuel cell having one electricity-generating unit 11 shown in the second embodiment. Additionally, other constitutions and conditions were the same as in Example 1.

Aging was conducted in the same manner as in Example 1, and α values finally obtained are shown in Table 5.

TABLE 5
Results in the test conducted under a load of a
constant electric current density, calculated cross-over
ratio and number of entrained water

| | | |
|---|---|---|
| Electricity-generating | 60 | 60 |
| temperature (° C.) | | |
| Area of electricity- | 12 | 12 |
| generating portion (cm²) | | |
| Current density (A/cm²) | 0.15 | 0.15 |
| under a constant load | | |
| Fuel concentration (M) | 2 | 1 |
| Fuel-supplying amount | 0.15 | 0.43 |
| (cc/min) | | |
| Air-supplying amount | 60 | 60 |
| (cc/min) | | |
| Total amount of recovered | 0.648 | 0.540 |
| discharged water (g/h) | | |
| Amount of discharged gas | 54 | 54 |
| (cc/min) | | |
| Concentration of carbon | 3.7 | 2 |
| dioxide in the discharged | | |
| gas (%) | | |
| Output voltage (V/cm²) one | 0.390 | 0.420 |
| hour after initiation of | | |
| applying a constant load | | |
| Cross-over ratio (%) | 32.3 | 20.5 |
| Number of entrained water | −0.123 | −0.139 |
| (α value) | | |

Here, the α value of the direct methanol fuel cell shown in the second embodiment can be maintained at a level of 0 or lower. Further, as is shown in Table 5, electricity was able to be generated both in the case where fuel concentration of the fuel supplied from the fuel-supplying inlet 12 was 2.0 mol/l and in the case where the concentration was 1.0 mol/l. That is, in comparison with the electricity-generating unit 11 shown in the first embodiment, the electricity-generating unit 11 shown in the second embodiment can generate electricity with a less amount of the fuel supplied.

With the anode MPL layer 26 in the first embodiment, it is difficult for the fuel to diffuse through the region of the anode catalyst layer 22 with which the anode MPL layer 26 divided by cracks contacts, thus the efficiency of generating electricity tending to decrease. With the anode MPL layer 26 in the second embodiment, however, the second MPL layer 26-2 having the structure wherein pores of about ten and several μm in diameter are uniformly distributed is provided in contact with the anode catalyst layer 22 and, therefore, the fuel can diffuse more easily and electricity can be generated with a fuel of lower concentration. This serves to suppress cross-over of methanol.

It has conventionally been accepted that generation of electricity with a fuel having a low methanol concentration and reduction of the α value are difficulty compatible. However, the direct methanol fuel cell of the second embodiment can attain both generation of electricity with a fuel having a low methanol concentration and reduction of the α value.

### Example 5

With the direct methanol fuel cells of the first and second embodiments, a rapid increase in the α value has been experienced in some cases when generation of electricity is continued for a long period of time, for example for several ten hours or longer. The reason for this is considered as follows. Within a short period of time from initiation of generating electricity, invasion of the fuel into the anode MPL layer 26 can be sufficiently prevented. However, since cracks exist in the anode MPL layer 26, it becomes easy for the fuel to invade into the anode MPL layer 26, and the amount of fuel passing through the cracks increases

It was able to be confirmed that, when generation of electricity was continued for 200 hours or longer using the direct methanol fuel cell shown in the fourth embodiment, the α value does not rapidly increase.

The above embodiments can provide a direct methanol fuel cell which can suppress diffusion of water from the anode electrode to the cathode electrode and enables use of a fuel having a higher concentration of methanol.

While the embodiments and the examples according to the invention have been described above, the invention is not restricted to such configurations but various changes can be made without departing from the technical thought of the invention.

What is claimed is:

1. A direct methanol fuel cell comprising:
an electrolyte membrane;
an anode catalyst layer provided on one side of the electrolyte membrane, the anode catalyst layer accelerating the reaction of methanol with water to produce proton, electron and carbon dioxide;
a cathode catalyst layer provided on the other side of the electrolyte membrane, the cathode catalyst layer accelerating the reaction between the proton, the electron and oxygen to produce water;
a dense water-repelling layer having water-repelling property provided on the opposite side of the anode catalyst layer to the electrolyte membrane, the dense water-repelling layer being formed by calcining a slurry containing carbon powder and water-repelling polymer and having a thickness of 100 μm or more after calcination; and
a porous gas-diffusing layer provided on the opposite side of the dense water-repelling layer to the anode catalyst layer.

2. The direct methanol fuel cell as described in claim 1, wherein the dense water-repelling layer includes: a first anode MPL layer formed on the porous gas-diffusing layer side; and a second anode MPL layer formed on the anode catalyst layer side by forming a spraying method.

3. A production method of a direct methanol fuel cell comprising:
coating a slurry containing carbon powder and water-repelling polymer; and
calcining the slurry,
wherein the direct methanol fuel cell having,
an electrolyte membrane,
an anode catalyst layer provided on one side of the electrolyte membrane, the anode catalyst layer accelerating the reaction of methanol with water to produce proton, electron and carbon dioxide,
a cathode catalyst layer provided on the other side of the electrolyte membrane, the cathode catalyst layer accelerating the reaction between the proton, the electron and oxygen to produce water,
a dense water-repelling layer having water-repelling property provided on the opposite side of the anode catalyst layer to the electrolyte membrane, the dense water-repelling layer being formed by calcining the slurry and having a thickness of 100 μm or more after calcination, and
a porous gas-diffusing layer provided on the opposite side of the dense water-repelling layer to the anode catalyst layer.
